(19) United States
(12) Patent Application Publication
(10) Pub. No.: US 2004/0253961 A1
(43) Pub. Date: Dec. 16, 2004

(54) Mobile communication system for establishing call a connection state and a method for establishing a call connection state using the same

(76) Inventors: Dong-Keon Kong, Suwon-si (KR); Tae-Won Kim, Yongin-si (KR); Hong-Sung Chang, Suwon-si (KR); Seung-Il Yoon, Seongnam-si (KR); Jong-Bum Pyo, Yongin-si (KR); Dae-Gyun Kim, Seongnam-si (KR); Beom-Sik Bae, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/867,642

(22) Filed: Jun. 16, 2004

(30) Foreign Application Priority Data
Jun. 16, 2003 (KR) 2003-38881

(51) Int. Cl. H04Q 7/20

(52) U.S. Cl. 455/450; 455/516

(57) ABSTRACT

A call setup system and method for a mobile station in a dormant state in a mobile communication system supporting a Short Data Burst (SDB). The system and method comprise setting fields to call setup request values in an SDB signal message, transmitting the signaling message including the fields to an access network, and establishing a traffic channel in response to channel assignment information corresponding to the SDB signal message if the access network transmits the channel assignment information; and transmitting a response message to the SDB signal message to the mobile station, and at the same time transmitting a traffic channel assignment message to the mobile station in response to the call setup request values included in the SDB signal message.

### PRIORITY

This application claims the benefit under 35 U.S.C. § 119(a) of an application entitled “MOBILE COMMUNICATION SYSTEM FOR ESTABLISHING CALL CONNECTION STATE AND METHOD FOR ESTABLISHING CALL CONNECTION STATE USING THE SAME”, filed in the Korean Intellectual Property Office on Jun. 16, 2003 and assigned Serial No. 2003-38881, the entire contents of which are incorporated herein by reference.

### BACKGROUND OF THE INVENTION

1. Field of the Invention

The present invention relates to a mobile communication system and method for establishing a call connection state. More particularly, the present invention relates to a system and method for establishing a call connection state for a mobile station in a dormant state.

2. Description of the Related Art

A mobile communication system is classified into a system for supporting a voice service and a system for supporting a data service. A representative example of the mobile communication system is indicative of a Code Division Multiple Access (CDMA) system. Presently, a system for supporting only the voice service in the CDMA system is based on the International Standard (IS) _{—}95 standard and its associated standards. With the advancement of communication technologies, a mobile communication system is being developed to support a high-speed data service. For example, the first generation CDMA 2000 (also known as CDMA 2000 1X) has been designed to concurrently support both a voice service and a high-speed data service.

A conventional method for establishing or clearing a call connection state in the aforementioned mobile communication system will now be described with reference to FIG. 1.

FIG. 1 is a flow chart illustrating a call setup procedure and a call release procedure in the mobile communication system. Referring to FIG. 1, if a mobile station 10 is in an idle state, a call connection state between the mobile station 10 and an access network 20 is established according to either a call origination signal of the mobile station 10 or a paging signal of the access network 20 at step 101. A traffic channel is assigned to a mobile station 10 at step 102, and a service configuration is negotiated between the mobile station 10 and the access network 20, at step 103 so that the mobile station 10 is transitioned from the idle state to the active state. Traffic, such as a voice signal and data, is communicated between the mobile station 10 and the access network 20 using the service configuration at step 104. If there is no more data to be transmitted during transmission of the traffic, the mobile station 10 is transitioned to a dormant state. If data to needs to be re-transmitted, the mobile station 10 in the dormant state performs a re-activation process at step 105, such that it re-establishes the call connection state. After all of the data transmission steps have been performed, the call connection mode between the mobile station 10 and the access network 20 is cancelled at step 106, so that the mobile station 10 is transitioned to the idle state.

The mobile station 10 exchanges a Service Request Message (SRQM) and a Service Response Message (SRPM) with the access network 20, and negotiates a service parameter with the access network 20 at step 103, indicative of the service negotiation step. The negotiated service parameter is mapping-processed with a Service Configuration Synchronization Identifier (SYNC_ID) by means of a base station. The access network 20 transmits the SYNC_ID and a service configuration parameter to the mobile station 10 via a Service Connect Message (SCM). If the mobile station 10 approves an access request in response to a service access message, the voice signal or data is transmitted or received to and from a system using the negotiated service configuration.

When the mobile station 10 transitioned from the traffic transmission state to the dormant state communicates with a remote computer using a Peer-To-Peer (PTP) scheme or a Client & Server scheme, the following two methods are used, and their detailed description will now be described.

As to the first method, when a signal is transmitted or received, a traffic channel is first established, and a signal message is transmitted over the traffic channel.

Referring now to the second method, if the magnitude of the signal message is low, the traffic channel is not opened and the signal message in the form of a Short Data Burst (SDB) is transmitted to the access network 20. Thereafter, if media transmission is required, the traffic channel is established.

In the case of the second, method, if a call setup is not established, the mobile station 10 transmits the SDB to the remote computer over an access channel or an enhanced access channel, receives a Layer 2 ACK signal, and immediately establishes a traffic channel. The second method will now be described.

As stated above, the SDB may be adapted when the mobile station transitions to the dormant state and transmits a small frame. If the setup call is not found, the SDB is transmitted over the access channel or the enhanced access channel. Otherwise, if the setup call is found, the SDB is transmitted over the traffic channel. Data in the form of the SDB is transmitted to a Packet Call Function (PCF) over the mobile station 10 and the access network 20. The SDB data is loaded on a Data Burst Message (DBM). The SDB data loaded on the DBM is transmitted to an air interface. FIG. 2 is a block diagram illustrating internal configurations of conventional SDB and DBM.

FIG. 3 is a flow chart illustrating a conventional traffic channel setup procedure. The mobile station 10 in the dormant state transmits a signal message in the form of the SDB to the access network 20 at step 301. The access network 20 transmits the signal message to the remote computer 30 at step 302. The access network 20 transmits a Layer 2 (L2) ACK signal to the mobile station 10 as a response to the received SDB message at step 303. The mobile station 10 having received the L2 ACK signal transmits an origination message or a reconnection message to the access network 20 at step 304. The access network 20 answers the origination message or the reconnection message, and transmits an Extended Channel Assignment Message (ECAM) indicative of channel assignment to the mobile station 10 at step 305. The mobile station 10 recognizes that a Base Station (BS) has established a traffic channel using the ECAM. The mobile station 10 and the access network 20 negotiate a service for determining traffic setup parameters at step 306. The remote computer 30 transmits a response to the signal message to the access network 20 at step 307. Upon receiving the signal message from the remote computer 30, the access network 20 transmits the signal message to the mobile station 10 at step 308. If the traffic channel setup has already been completed, the access network 20 transmits the signal message over the traffic channel. If the traffic channel setup is in progress, the access network 20 transmits the signal message in the form of the SDB to the mobile station 10 over a paging channel or a Forward-Common Control Channel (F-CCCH).

As stated above, the mobile station 10 transitioned to the dormant state gains access to the system so as to transmit the signal message to the remote computer 30, and also gains access to the access network 20 so as to transmit the origination message or the reconnection message at step 301, so that the traffic channel is established. Specifically, the mobile station 10 transmits an access request to the system two times in order to transmit the SDB and the origination or reconnection message. If the mobile station 10 transmits the SDB and receives the L2 (Layer 2) ACK message, an initiation message or a reconnection message is transmitted so that an unexpected latency is encountered. Due to this problem, a Quality of Service (QoS) deteriorates in the case of a group call service very sensitive to the latency.

With the increasing development of the mobile communication system, a variety of applications have been developed for the CDMA mobile communication system, for example, a system for providing voice and data services, a system for providing only a high-speed data service, and a system for providing the voice service and the high-speed data service, and so on. As such a mobile communication system has become diverse, the voice service has been developing in the direction from a 1:1 communication scheme (also called a Peer-To-Peer communication scheme) to more diverse communication schemes, for example, a group conference communication and a short message communication, and so on.

Usually, the short message communication is indicative of a Push To Talk (PTT) communication. For the short message communication, after a plurality of users start generating initial calls, any user who wishes to talk with another party presses a push button installed in a mobile station so as to attempt initiation of voice communication. If there is a call request generated from the mobile station, the mobile communication system for providing the short message communication service transmits the voice signal to other users. All other users who do not wish to transmit their voice signals receive the voice signal from the mobile station that generated the call request.

Most short message communications have been used among users who belong to a specific group. For example, the short message communication may be implemented with a phone reservation service between members of a taxi association so that one-way communication between a reservation request receiver and the members of the taxi association can be established. Also, the short message communication may be adapted to substitute for walkie-talkies in the construction field. In this way, the aforementioned short message communication has been adapted to only a few applications. There is a need for the aforementioned short message communication service to be extended to users who receive typical mobile communication terminal services, such that the short message communication service must be applied to small-sized group communication or extremely-limited Peer-To-Peer communication. Therefore, system developers have been conducting intensive research into a new technology capable of providing an improved communication service in the same manner as in the packet data service. However, the packet data service unavoidably generates a latency (i.e., time delay) of a packet call. Therefore, if the latency of the packet call is applied to the short message communication, a long latency occurs when an origination call is generated in the dormant state. In this manner, in the case of voice communication, the aforementioned latency may have a negative influence upon QoS as compared to the packet data service.

Also, the system access is established over the access channel or the enhanced access channel. The access channel uses a random access scheme because a plurality of users may transmit access requests. If system access failure occurs, the mobile station increases power and transmits the increased power at each access probe. The access probe generates a latency for a predetermined time to prevent data collision from being generated.

In conclusion, when a service in which rapid access (e.g., a Push To Talk service) is required in an air interface area, a plurality of terminals frequently request access to the system in the aforementioned conventional system, such that system load unavoidably increases.

### SUMMARY OF THE INVENTION

Therefore, the present invention has been made in view of the above problems, and it is an object of the present invention to provide a system and method for reducing a call setup time of a mobile station.

It is another object of the present invention to provide a method for reducing system load generated by a system access task required for a call setup task of a mobile station.

In accordance with one aspect of the present invention, the above and other objects can be accomplished by the provision of a call setup method for a mobile station in a dormant state in a mobile communication system supporting a Short Data Burst (SDB). The method comprises setting, by the mobile station, fields to call setup request values in an SDB signal message, and transmitting the signal message including the fields to an access network; transmitting, by the access network, a response message to the SDB signal message to the mobile station, and at the same time transmitting a traffic channel assignment message to the mobile station in response to the call setup request values contained in the SDB signal message; and establishing a traffic channel in response to the channel assignment information if the access network transmits channel assignment information in response to the SDB signal message.

In accordance with another aspect of the present invention, there is provided a call setup system for a mobile station in a dormant state in a mobile communication system supporting a Short Data Burst (SDB). The system comprises the mobile station adapted to set fields to call setup request values in an SDB signal message, transmit the signaling message including the fields to an access network, and establish a traffic channel in response to channel assignment information corresponding to the SDB signal message if the access network transmits the channel assignment information; and the access network adapted to transmit a response message to the SDB signal message to the mobile station, and at the same time transmit a traffic channel assignment message to the mobile station in response to the call setup request values included in the SDB signal message.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flow chart illustrating a conventional call setup procedure and a call release procedure in a mobile communication system;

FIG. 2 is a view illustrating internal configurations of a Data Burst Message (DBM) and a Short Data Burst (SDB);

FIG. 3 is a flow chart illustrating a conventional traffic channel setup procedure;

FIG. 4 is a diagram illustrating an SDB configuration in accordance with an embodiment of the present invention;

FIG. 5 is a diagram illustrating a Non-Negotiable Service Configuration Record (NNSCR) configuration in accordance with an embodiment of the present invention;

FIG. 6 is a flow chart illustrating a traffic channel setup procedure in accordance with an embodiment of the present invention; and

FIG. 7 is a flow chart illustrating a traffic channel setup procedure in accordance with another embodiment of the present invention.

Throughout the drawings, it should be noted that the same or similar elements are denoted by like reference numerals.

### DETAILED DESCRIPTION OF THE PREFERRED EMBODIMENTS

Embodiments of the present invention will be described in detail with reference to the accompanying drawings. In the following, a detailed description of known functions and configurations incorporated herein will be omitted for conciseness.

The embodiments of the present invention provide an improved method in which a mobile station, which is in a dormant state in an access network capable of supporting a Short Data Burst (SDB), transmits the SDB as a signal message, and at the same time requests a system to establish a traffic channel. Specifically, when transmitting an initial signal message, the mobile station inserts a Service Configuration Synchronization Identifier (SYNC_ID) in an SDB type inside of the Data Burst Message (DBM). The access network transmits SDB data loaded on the DBM to the remote computer, and performs a traffic channel setup process with reference to the SYNC_ID. Therefore, the mobile station need not re-transmit an origination message or a reconnection message for a traffic re-activation procedure, resulting in a reduction in a call setup time.

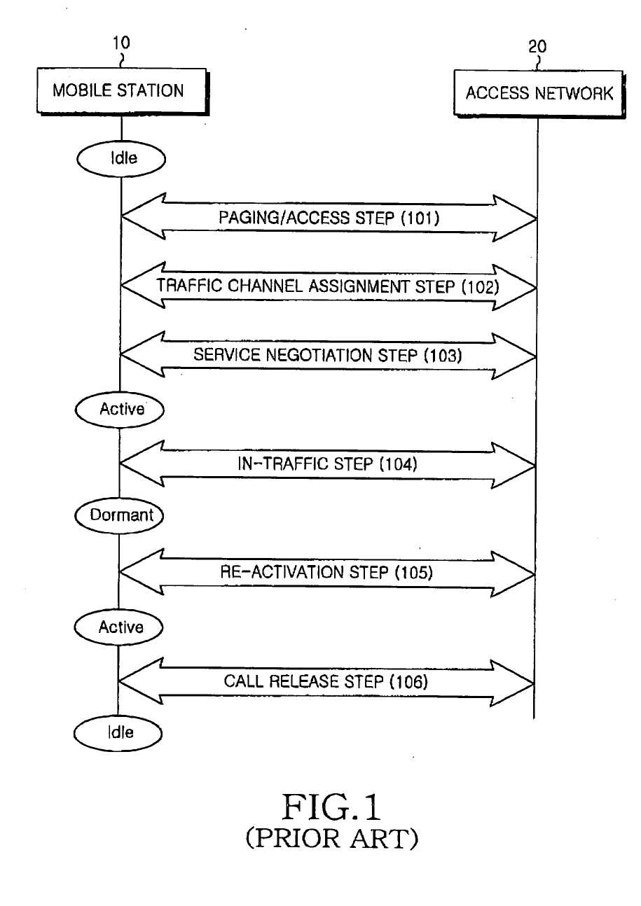

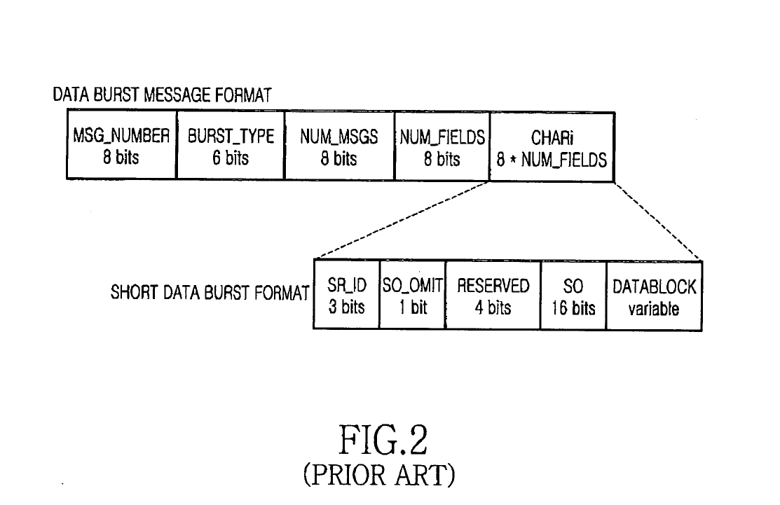

If the access network receives the SDB with the SYNC_ID, it starts establishing a traffic channel in the same manner as if the origination message or the reconnection message is received. A service configuration parameter uses pre-stored values, which have been mapping-processed with the SYNC_ID as shown in FIG. 1.

The mobile station and the access network are considered to be in a dormant state in which traffic channel assignment information and connection information needed for network connection are stored. In the dormant state, a radio traffic channel is cancelled or released during a time interval in which there is no burst traffic of a data service, and the mobile station and the radio network stores only reconnection-associated information.

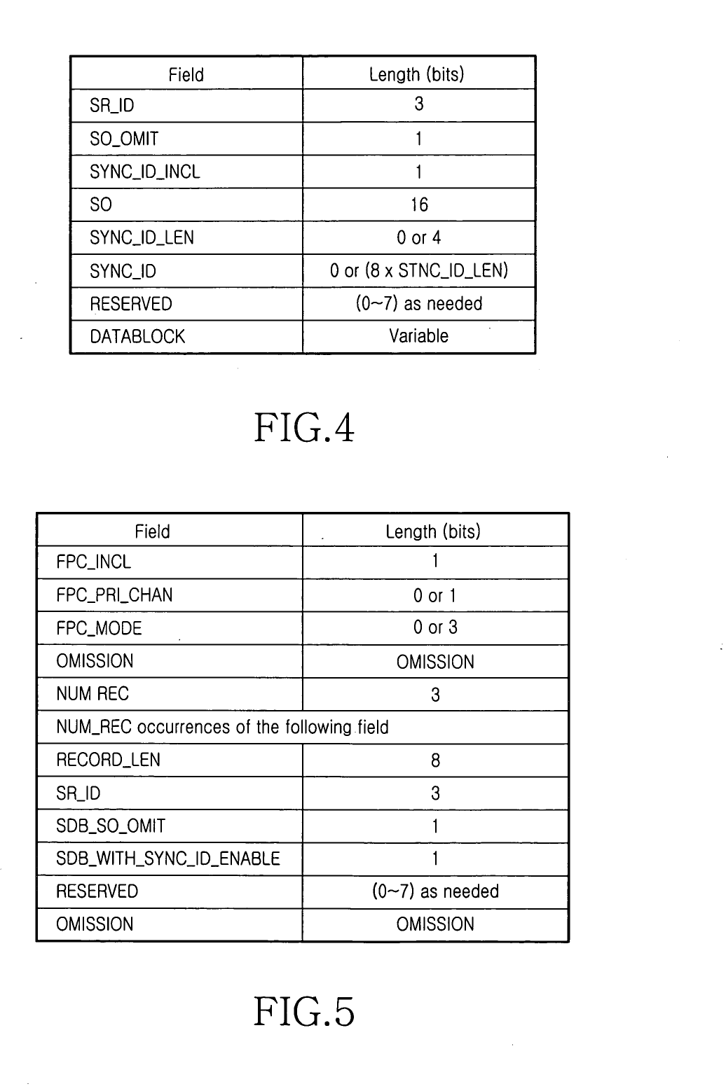

In the case where the mobile station transitioned to the dormant state transmits the SDB, it adds the SYNC_ID received at a service negotiation time between the mobile station and the access network to the SDB. A method for adding the SYNC_ID to the SDB message format will hereinafter be described with reference to FIG. 4. FIG. 4 is a diagram illustrating an SDB configuration in accordance with an embodiment of the present invention.

As well known in the art, the SDB is indicative of a technique for transmitting a limited amount of data (mainly text) over a common channel or paging/access channel based on the Code Division Multiple Access (CDMA) 2000 1X standard. The common channel performs signaling and control operations between a mobile station in an idle state and a radio access network. The SDB message service has an advantage in that it can transmit or receive data without the burden of traffic channel assignments, such that it is currently supported by most cellular mobile communication systems including the CDMA system.

An embodiment of the present invention transmits signaling messages (i.e., request/response messages) over forward and reverse common channels. In this case, the signaling message is configured in the form of the SDB. It should be understood that the PTT signaling message in an embodiment of the present invention is transmitted over a Forward Common Control Channel (F-CCCH) and a Reverse Extended Access Channel (R-EACH) or a paging or access channel.

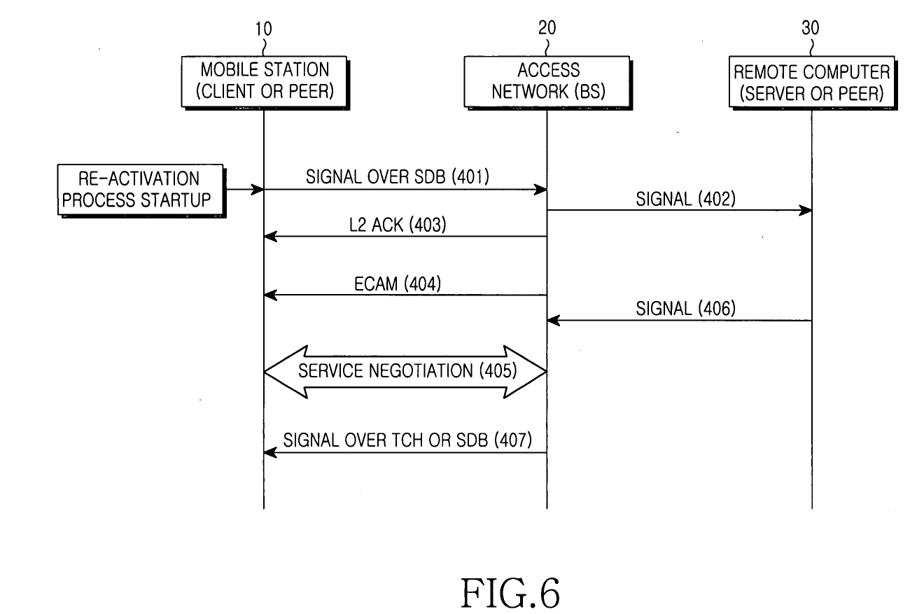

The mobile station loads the SDB on a quickly-transmissible Data Burst Message instead of the traffic channel, and thereby the SDB loaded on the DBM is transmitted over a common channel. The SDB further includes a Synchronization Identifier Length (SYNC_ID_LEN) field and a Synchronization Identifier (SYNC_ID) field. The first reserved bit from among four reserved bits of the SDB is adapted as a SYNC_ID_INCL bit for determining whether the SYNC_ID field is included in the SDB. More specifically, if the reserved bit inside of the SDB is set to ‘1000’, new fields (i.e., the SYNC_ID_LEN and SYNC_ID fields) are further included in the SDB. If the reserved bit is set to ‘0000’, the SYNC_ID_LEN and SYNC_ID fields are omitted. The reserved bit is adapted to adjust octet information. Only when the SDB_WITH_SYNC_ID_ENABLE field of the last Non-Negotiable Service Configuration Record (NNSCR) is set to ‘1’, the mobile station transmits the SDB with the SYNC_ID in the dormant state. Specifically, in the case where the BS transmits the SDB and at the same time supports a traffic channel setup operation, the SDB_WITH_SYNC_ID_ENABLE field of the NNSCR is set to ‘1’. Otherwise, the SDB_WITH_SYNC_ID_ENABLE field of the NNSCR is set to ‘0’. A method for extending a record including an SDB_SO_OMIT of the NNSCR is shown in FIG. 6.

FIG. 6 is a flow chart illustrating a traffic channel setup procedure in accordance with an embodiment of the present invention.

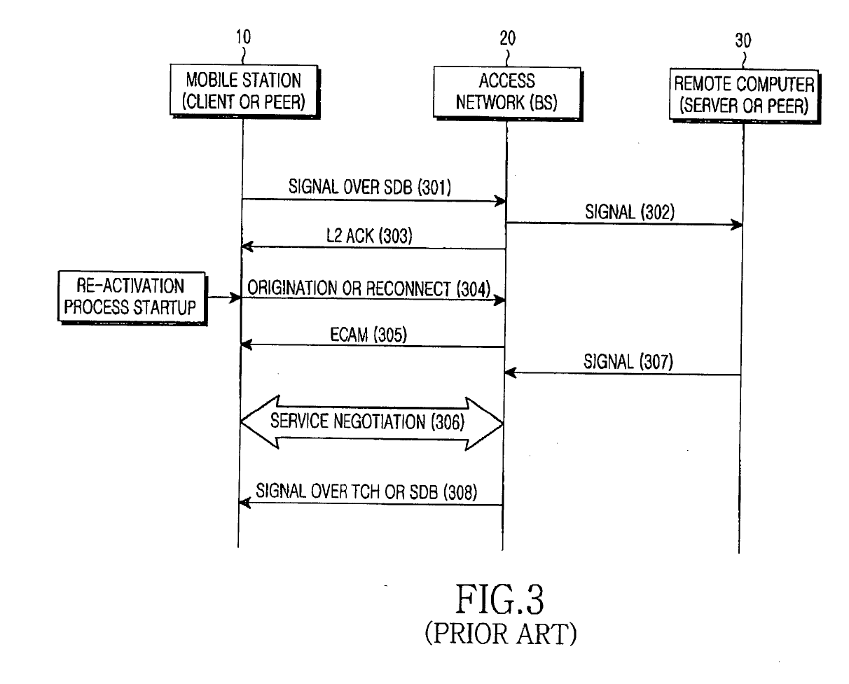

The mobile station 10 in the dormant state transmits a signal message to the access network 20 using the SDB including the SYNC_ID at step 401 in a similar manner as in FIG. 3, so that a traffic channel can be established. The access network 20 transmits the signal message to a remote computer 30 at step 402. The access network 20 transmits an L2 ACK signal to the mobile station as a response to the received SDB at step 403. The access network 20 transmits an Extended Channel Assignment Message (ECAM) signal according to a parameter mapping-processed with the SYNC_ID included in the SDB at step 404. Upon receiving the ECAM signal from the access network 20, the mobile station 10 recognizes that the BS has established the traffic channel. The mobile station 10 negotiates a service with the access network 20 at step 405, but step 405 can be omitted if needed. The remote computer 30 transmits a response to the signal message to the access network 20 at step 406. If the traffic channel setup has already been completed, the access network 20 transmits the signal message over the traffic channel. If the traffic channel setup is in progress, the access network 20 transmits the signal message in the form of the SDB to the mobile station 10 over a paging channel (or a Forward-Common Control Channel (F-CCCH)).

Another embodiment of the present invention for the Press To Talk (PTT) service will now be described.

Detailed operations of an embodiment of the present invention will be described on the basis of a mobile communication system which uses the CDMA2000 1X standard and its associated air interface standard. It should be appreciated by those skilled in the art that, the call setup technique can be applied to other mobile communication systems including similar technical background and channel information without departing from the scope of the present invention.

Although radio access networks and other network elements such as a Public Data Switched Network (PDSN) are not shown in the drawings, it should be understood that message generated among talkers or listeners and a PTT server is transmitted over radio access networks and PDSNs. Likewise, it should also be understood that radio channels are positioned among talkers or listeners and radio access networks.

The following embodiment of the present invention reduces latency (also called time delay) associated with a call setup function simultaneously with rapidly establishing a traffic channel for PTT communication in the case of providing a group call service (e.g., a Peer To Peer (PTP) communication service) using a radio network. Particularly, if the mobile station requests the PTT service using a reverse radio link, an embodiment of the present invention transmits an initial PTT request message in the form of an SDB, and establishes a radio traffic channel between the mobile station and the access network before receiving a response to the initial PTT request message.

The faster the setup time, from the time at which a user presses the Push button the time at which the user hears a grant tone indicative of an approved user's call establishment, the higher the validity of the PTT service.

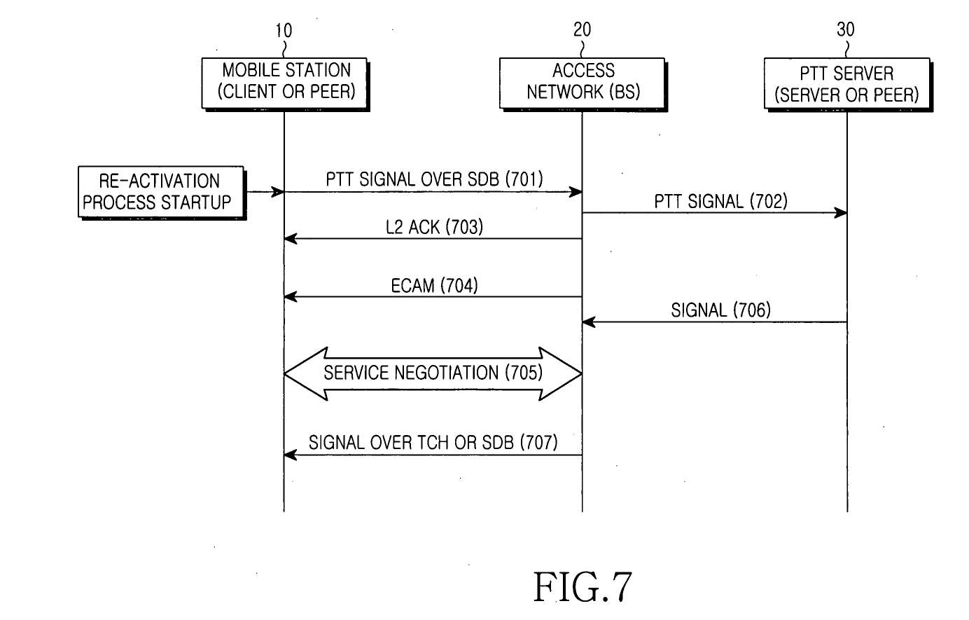

A call setup method in a dormant state of the PTT service will now be described with reference to FIG. 7.

The mobile station 10 answers the PTT button pressed by the user, and transmits a PTT request message in the form of the SDB to the access network 20 at step 701. In this case, the SDB includes the SYNC_ID field as previously stated above. Upon receipt of the signal message equal to the PTT request message, the access network 20 transmits the signal message to the PTT server 30 at step 702. The access network 20 transmits an ACK message associated with the SDB to the mobile station 10 at step 703. The access network 20 performs a traffic channel setup procedure using the SYNC_ID contained in the SDB, and transmits a channel assignment message to the mobile station 10 at step 704. The mobile station 10 and the access network 20 perform a service negotiation procedure at step 705, but step 705 can be omitted if needed. The PTT server 30 transmits a response message to the signal message to the access network 20 at step 706. After the PTT server 30 performs a floor arbitration process at step 706, the response message is a grant or rejection message generated by the presence or absence of a current talker. If the traffic channel setup has already been completed, the access network 20 having received the signal message from the PTT server 30 transmits the signal message over the traffic channel. If the traffic channel setup is in progress, the access network 20 transmits the signal message in the form of the SDB to the mobile station 10 over a paging channel (or an F-CCCH). If a floor grant message is transmitted to the mobile station 10, the user can hear the grant tone. If this embodiment of the present invention is applied to the PTT service, a setup time, from the time at which a user presses the Push button to the time at which the user hears the grant tone is reduced.

The delay required for a call setup operation until the establishment of the traffic channel after the SDB is transmitted at step 301 of the conventional art can be compared with the delay required for a call setup operation at step 401 as follows.

The latency of the conventional art is equal to the sum of an L2 ACK reception time and a reactivation time.

However, if a reactivation time is longer than the L2 ACK reception time, the latency of the present invention is equal to the reactivation time.

Therefore, the latency can be reduced by the L2 ACK reception time.

As apparent from the above description, the embodiments of the present invention control a mobile station to transmit an extended SDB including a SYNC_ID field in order to request a traffic channel setup, such that a traffic channel setup time in a dormant state can be reduced. Furthermore, the mobile station can reduce the number of system access times until the traffic channel is established, resulting in a reduction of the system load.

Although certain embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A call setup method for a mobile station in a dormant state in a mobile communication system supporting a Short Data Burst (SDB), comprising the steps of:
setting, by the mobile station, fields to call setup request values in an SDB signal message, and transmitting the signal message including the fields to an access network;
transmitting, by the access network, a response message to the SDB signal message to the mobile station, and at the same time transmitting a traffic channel assignment message to the mobile station in response to the call setup request values included in the SDB signal message; and
establishing a traffic channel in response to the channel assignment information if the access network transmits channel assignment information in response to the SDB signal message.

2. The method according to claim 1, wherein the call setup request values each comprise a Synchronization Identifier (SYNC_ID ) identifying a service configuration received from the access network when the mobile station negotiates a service accompanied by a traffic channel setup request with the access network prior to entering the dormant state.

3. The method according to claim 2, wherein the SDB signal message includes a SYNC_ID_LEN (Synchronization Identifier Length) field and a SYNC_ID field.

4. The method according to claim 2, wherein the transmitting step comprises:
assigning, by the access network, a traffic channel using a service configuration parameter mapping-processed with the SYNC_ID included in the SDB.

5. The method according to claim 1, wherein the SDB signal message is transmitted over a Forward Common Control Channel (F-CCCH) and a Reverse Extended Access Channel (R-EACH), or is transmitted over a paging/access channel.

6. The method according to claim 1, wherein:
the SDB signal message is transmitted to a remote computer over the access network, and
a response message to the SDB signal message is transmitted from the remote computer to the traffic channel over the access network if the traffic channel has been established, or is transmitted from the remote computer to a paging channel over the access network if establishment of the traffic channel is in progress.

7. A call setup method for a mobile station in a dormant state in a mobile communication system supporting a Short Data Burst (SDB), comprising the steps of:
the mobile station adapted to set fields to call setup request values in an SDB signal message, transmit the signaling message including the fields to an access network, and establish a traffic channel in response to channel assignment information corresponding to the SDB signal message if the access network transmits the channel assignment information; and
the access network adapted to transmit a response message to the SDB signal message to the mobile station, and at the same time transmit a traffic channel assignment message to the mobile station in response to the call setup request values included in the SDB signal message.

8. The system according to claim 4, wherein the call setup request values each comprise a Synchronization Identifier (SYNC_ID) identifying a service configuration received from the access network, when the mobile station negotiates a service accompanied by a traffic channel setup request with the access network prior to entering the dormant state.

9. The system according to claim 7, wherein the SDB signal message includes a SYNC_ID_LEN (Synchronization Identifier Length) field and a SYNC_ID field.

10. The system according to claim 5, wherein the access network assigns a traffic channel using a service configuration parameter mapping-processed with the SYNC_ID included in the SDB.

11. The system according to claim 7, wherein the SDB signal message is transmitted over a Forward Common Control Channel (F-CCCH) and a Reverse Extended Access Channel (R-EACH), or is transmitted over a paging/access channel.

12. The system according to claim 7, wherein:
the SDB signal message is transmitted to a remote computer over the access network, and
a response message to the SDB signal message is transmitted from the remote computer to the traffic channel over the access network if the traffic channel has been established, or is transmitted from the remote computer to a paging channel over the access network if establishment of the traffic channel is in progress.
